(19) United States
(12) Patent Application Publication
(10) Pub. No.: US 2009/0171678 A1
(43) Pub. Date: Jul. 2, 2009

(54) PROTECTING DOMAIN NAMES FROM UNDESIRED TRANSFER

(76) Inventors: Michael Zimmerman, Scottsdale, AZ (US); Justin Jilg, Mesa, AZ (US); Nate Curran, Phoenix, AZ (US); Ryan Corder, Phoenix, AZ (US)

Correspondence Address: GO DADDY GROUP, INC., 14455 NORTH HAYDEN ROAD, SUITE 219, SCOTTSDALE, AZ, 85260, US

(21) Appl. No.: 11/964,560

(22) Filed: Dec. 26, 2007

(51) Int. Cl. G06Q 30/00

(52) U.S. Cl. 705/1

(57) ABSTRACT

Systems and methods are disclosed for protecting a domain name during a sale of shares of equity in the domain name. Prior to and during the sale of shares of equity in the domain name, the domain name is moved into a holding account as collateral for the sale of shares of equity. This protection may include registrar protection, such as expiration protection or hijack protection, or legal protection and rights such as trademark protection (including specialized ICANN protections) and copyright protection. The domain owner may also make use of an Internet-related business setup, including e-commerce and web content design, development, coding and configuration.

### FIELD OF THE INVENTION

The present invention relates to the field of domain names and, more specifically, systems and methods for underwriting, protecting and starting an Internet business for a domain name during the sale of shares of equity in the domain name.

### BACKGROUND OF THE INVENTION

The Internet is a worldwide network of computers and computer networks arranged to allow the easy and robust exchange of information between the users of the computers. The combination of all the websites and their corresponding web pages on the Internet is generally known as the World Wide Web (web).

Users of the Internet may access content providers' websites using a software package known as a web browser, such as MICROSOFT INTERNET EXPLORER, MOZILLA FIREFOX or NETSCAPE NAVIGATOR. Browsers are able to locate specific websites because each website, resource and computer on the Internet has a distinct Internet Protocol (IP) address. Each IP address is a 32-bit binary number, but is typically shown in dotted decimal notion, e.g. 192.145.68.112, to improve human readability. However, IP addresses, even in dotted decimal notation, are difficult to remember and use by people. Uniform Resource Locators (URL) are much easier to remember and may be used to point to a computer, directory or file on the Internet. A browser is able to access a website on the Internet through the use of a URL. The URL may include a Hypertext Transfer Protocol (HTTP) request combined with the website's internet address, also known as the website's domain name.

Individuals, companies, and other entities that provide content on the web generally want to use their name or one of their trademarks as part of their domain name. Thus, domain names are generally company trademarks, personal names or short phrases concatenated with a top level domain name (TLD) extension (e.g. .com, .net, .org, .us, .biz, etc.). Domain names created in this fashion are much easier to remember and use than their corresponding IP addresses. The Internet Corporation for Assigned Names & Numbers (ICANN) approves all TLDs and delegates the responsibility to a particular organization (Registry) for maintaining an authoritative source for the registered domain names within a TLD and their corresponding IP addresses. There is one organization, or Registry, for each of the ICANN approved TLDs. For certain TLDs, e.g. .biz, .info, .us, the Registry is also the authoritative source for contact information related to the domain name. For other TLDs, e.g. .com, .ws, .org, .net, a Registrar may be the authoritative source for the contact information related to the domain name. A Registrant refers to the owners of a domain name. All domain names are managed through a central domain name Shared Registration System (SRS) based on their TLD.

Many registrants have recently expressed an interest in dealing with the expense required to improve the valuation of their domain names but do not have a means of creating capital in a secure way while protecting their valuable online property.

### SUMMARY OF THE INVENTION

The present invention provides systems and methods for underwriting a sale of shares of equity in a Domain Name, and protecting the Domain Name during the sale of shares of equity, thus overcoming substantial limitations in the relevant art.

An example embodiment may include underwriting a sale of shares of equity in a Domain Name and protecting the Domain Name during the sale of shares of equity in the Domain Name. Via a Central Repository of stored Domain Information, a Registrant submits Domain Information to a Network of Underwriters. The Registrant's Selected Proposal is chosen from presented underwriter Proposals and the Registrant then works with the selected underwriter to negotiate Domain Equity and Price Information including a number and price of shares to be offered in the Domain Name. The Registrant and the underwriter of the Selected Proposal then protect the Domain Name through Registrar protection and intellectual property protection from appropriate Government and/or Quasi-Government Agencies.

An exemplary system for underwriting the sale of shares of equity in a Domain Name may comprise one or more Registrant, one or more Domain Name, a plurality of Domain Information, one or more Central Repositories of Domain Information, a Network of Underwriters, a Selected Proposal from a plurality of underwriter Proposals, and negotiated Domain Equity and Price Information including number of equity shares and price per share. The Domain Information may further comprise Registrant information, a plurality of domain Related Organizations, a plurality of Domain Performance information, a plurality of domain related Business Plans, a plurality of Potential Investment Risks involved with investing in the Domain Name or any combination thereof. The Network of Underwriters may include Banks, syndicates of Banks, Venture Capitalists, Private Investors, Investment Houses, Insurers, any combination thereof or any other Financial Institution capable of underwriting the sale of shares of equity in a domain name.

An exemplary method of underwriting the sale of shares of equity in the Domain Name may comprise the steps of: accepting a submission of Domain Information from a Registrant of the Domain Name; submitting a Proposal to underwrite the sale of shares of equity in the Domain Name; and upon receiving notice of acceptance of the Proposal, negotiating Domain Equity and Price Information, including a number of shares available for sale and a price for each share.

An exemplary system for protecting a Domain Name during the sale of shares of equity in the Domain Name may comprise one or more Registrants, one or more Central Repositories of Domain Information, one or more Registrars, one or more Holding Accounts, one or more forms of Hijack Protection, one or more forms of Expiration Protection, means to secure Trademark Protection and Copyright Protection through the appropriate Government and/or Quasi-Government Agencies, and means for an Internet-Related Business Setup.

An exemplary method of protecting a Domain Name during the sale of shares of equity in the Domain Name may comprise the steps of: protecting a Domain Name from an undesired transfer of ownership during a sale of shares of equity in the Domain Name; transferring the Domain Name into a Holding Account during the sale of shares of equity in the Domain Name, protecting the Domain Name from theft through Hijack Protection during the sale of shares of equity in the Domain Name; protecting the Domain Name from a lapse in ownership through Expiration Protection during the sale of shares of equity in the Domain Name; offering Trademark Protection and legal rights including ICANN Protection and rights as recognized by one or more appropriate Government and/or Quasi-Government Agencies, offering Copyright Protection and rights as recognized by one or more appropriate Government and/or Quasi-Government Agencies; and offering and providing an Internet-Related Business Setup for the Domain Name during the sale of shares of equity in the Domain Name.

Additional advantages and aspects of the present invention will become apparent in the following detailed description and claims.

### BRIEF DESCRIPTION OF THE DRAWINGS

FIG. 1 illustrates a sample embodiment of a system for underwriting a sale of shares of equity in a Domain Name.

FIG. 2 is a flow diagram illustrating a sample embodiment of a method for underwriting a sale of shares of equity in a Domain Name.

FIG. 3 illustrates a sample embodiment of a system for protecting a Domain Name during the sale of shares of equity in the Domain Name.

FIG. 4 is a flow diagram illustrating a sample embodiment of a method for protecting the Domain Name during the sale of shares of equity in the Domain Name.

FIG. 5 is a streamlined flow diagram illustrating a sample embodiment of a method for underwriting a sale of shares of equity in a Domain Name and protecting the Domain Name during the sale of shares of equity in the Domain Name.

### DETAILED DESCRIPTION OF THE PREFERRED EMBODIMENTS

The present invention will now be discussed in detail with regard to the attached drawing figures, which were briefly described above. In the following description, numerous specific details are set forth, illustrating Applicants' best mode for practicing the invention and for enabling one of ordinary skill in the art to make and use the invention. It will be obvious, however, to one skilled in the art that the present invention may be practiced without many of these specific details. In other instances, well-known machines and process steps have not been described in particular detail in order to avoid unnecessarily obscuring the present invention. Unless otherwise indicated, like parts and processes are referred to with like reference numerals.

Overview

The domain name industry has reached an important point with regard to aftermarket investment. As more and more news sources cover the industry, more investment capital is finding its way to owners of the domain names (Registrants). Banks, venture capitalists and other financial institutions don't necessarily want to own domain names, but they do want equity in this valuable Internet property. Registrants, conversely, are interested in selling their domain names, but do not want to remove themselves from the industry and from the opportunity of owning an Internet business.

The sale of shares of equity in a Domain Name associated with the current invention simplifies the current rudimentary process by which Registrants attract investors through either knowing the party or being connected through outlets such as forums or other online media. Such a centralized sale of shares of equity would need to provide means to underwrite the sale of such equity and provide a means to protect the domain name from inadvertently or fraudulently being transferred to another entity.

The present invention fills the need for underwriting equity in and protecting a domain name during the sale of shares of equity in a domain name. For purposes of this disclosure, the phrase “during the sale of shares of equity in a domain name” should be understood to include the period between which a Registrant decides to create equity in a domain name through any initial or secondary sales of equity in the domain name.

A secure network of underwriters may desire to underwrite the sale of shares of equity in a registrant's domain name. The sale of shares of equity represents a significant commitment on the part of both the underwriters and the registrant. The underwriters, as well as the registrant may also desire to provide domain name protection to protect their domain name from lapse, hijacking or other means of fraudulent or negligent loss. Finally, the registrant may desire to use their domain to build an Internet-related business while protecting the intellectual property rights of the domain name.

The invention should have a desirable side effect on the entire domain name industry in that it may provide a significant amount of secure capital to registrants, which would allow them to develop their domain name organizations and invest in capital expenditures such as dedicated servers, other domain names, etc., while providing assurance to potential investors and underwriters that the domain name may be protected and used as collateral during the sale of such equity in the domain name.

A System for Underwriting Equity in a Domain Name

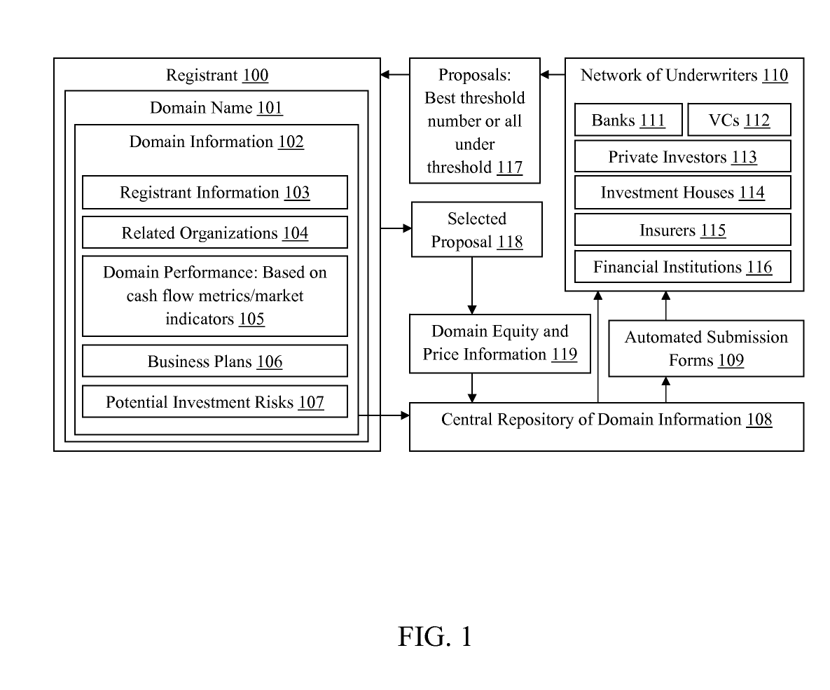

A sample embodiment of a system for underwriting equity in a domain name is illustrated in FIG. 1. The illustrated embodiment includes one or more Domain Names 101 and a Network of Underwriters 110 capable of underwriting a sale of shares of equity in the Domain Name 101.

The Network of Underwriters 110 may comprise any collection of financial service providers which assess the Domain Information 102 and take on a portion of the risk of distributing equity in the Domain Name 101 by providing access to equity capital, insurance or credit as needed. If there are not enough investors found during the sale of shares of equity in the Domain Name 101, the underwriters may hold some of the domain-name equity themselves.

As a non-limiting example seen in FIG. 1, the network of underwriters may comprise Banks 111, syndicates of Banks 111, Venture Capitalists 112, Private Investors 113, Investment Houses 114, Insurers 115, any other Financial Institutions 116 capable of underwriting the sale of shares of equity in a domain name, or any combination thereof.

Another embodiment includes one or more Registrants 100, one or more Domain Names 101 owned by the Registrant 100; a plurality of information relating to the Domain Name 101; one or more Central Repositories of Domain Information 108, including Domain Information 102 and capable of adding information relating to the Domain Name 101 or updating the Domain Information 102; a Network of Underwriters 1 10 capable of underwriting a sale of shares of equity in the Domain Name 101; a Selected Proposal 118 from among a plurality of underwriter Proposals 117; a plurality of Domain Equity and Price Information 119 related to a number of equity shares and price per share negotiated by the Registrant 100 and the underwriter of the Selected Proposal 118.

The Registrant 100 may comprise any individual or entity capable of owning a domain name, and listed in the WHOIS information related to a domain name. As non-limiting examples, the Registrant 100 may include a person, business, corporation or organization, any other entity capable of owning a domain name or any combination thereof. The Registrant 100 is the owner of the Domain Name 101, and the Registrant's responsibilities may include, but are not limited to initiating the decision to create shares of equity in the Domain Name 101, compiling and updating Domain Information 102, and submitting the Domain Information 102 to a Central Repository of Domain Information 108, where such information may be available to obtain underwriting of equity in the Domain Name 101, protection of the Domain Name 101 during the sale of shares of equity in the Domain Name 101 or as otherwise needed.

As seen in FIG. 1, the Domain Information 102 may further comprise Registrant Information 103, Related Organizations 104, Domain Performance 105, Business Plans 106 and Potential Investment Risks 107.

Registrant Information 103 may include personal information about the Registrant 100. As non-limiting examples Registrant Information 103 may include physical address information such as address, city, state and zip code information; WHOIS information as it typically relates to registrants; contact information such as telephone, cell phone, fax, email, etc.; any combination of the above, or any registrant information as it relates to the Domain Name 101 as is known in the art or which may be developed in the future.

The domain Related Organizations 104 may include any of the Domain Name's 101 Related Organizations 104 which use the Domain Name 101 to further the organization's purposes. Such Related Organizations 104 may include any organizations known in the art to utilize a domain name 101 such as Internet businesses, e-commerce organizations, “brick and mortar” businesses, non-profit organizations, or any other organization which currently uses or may find future uses for domain names.

Information related to Domain Performance 105 may be based on website traffic, cash flow metrics similar to typical business valuations or other market conditions and indicators. In a preferred embodiment, valuation based on Domain Performance 105 may use objective rather than subjective or intrinsic metrics related to the Domain Name 101. As non-limiting examples, sources of cash flow metrics may include website parking revenue, affiliate money, income from related domain names, any other known sources of cash flow metrics for domain names or any combination thereof. Non-limiting examples of market conditions and indicators, which may affect the Domain Performance 105, may include supply and demand, cost-benefit analysis, best cost-utility analysis, any other known market conditions and indicators known to affect domain name valuation on an open exchange or any combination thereof.

The domain related Business Plans 106 may outline the use of the Domain Name 101 to further the business goals of the Registrant 100 and/or any Related Organization 104. In an exemplary embodiment, such a plan may outline potential uses of business capital raised during the sale of shares of equity in the Domain Name 101. Such business capital may be used for capital expenditures including, but not limited to dedicated servers, other domain names, etc. The Registrant 100 may also outline Potential Investment Risks 107 associated with investing in the Domain Name 101.

The Central Repository of Domain Information 108 may store the Domain Information 102 and any information capable of being updated such as Domain Equity and Price Information 119 in a centralized location and may be accessible to the Network of Underwriters 110, or as otherwise needed within the system as a convenience to the Registrar 100, who is not then required to repeatedly re-submit the information.

Structurally, the Central Repository of Domain Information 108 may comprise any collection of data. As non-limiting examples, the Central Repository of Domain Information 108 may comprise a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, and/or other means of data storage located on one or more hosting server, a computer, a client, another server, or any other storage device or any combination thereof. In an alternate embodiment, the collection of data may be in hard-copy form, comprising any known form of compiling data and which may then be submitted in its existing form and which also allows access to such data.

The Selected Proposal 118 from the underwriter Proposals 117 may be based on the underwriter's competitive bid. The competitiveness of the bid may be based on the most mutually beneficial elements. As non-limiting examples, such elements may include best price, contract terms, best cost-benefit analysis, best cost-utility analysis, or any combination thereof. These examples are non-limiting; the Selected Proposal 118 may be based on any criteria deemed beneficial by the Registrant 100. The Proposals 117 bid by the Network of Underwriters 110 will likewise be based on the best investment opportunity provided as reflected through the Domain Information 102. These examples are also non-limiting and may likewise be based on any criteria deemed beneficial by the Network of Underwriters 110.

Domain Equity and Price Information 119 may be determined in a negotiated underwriting between the underwriter of the Selected Proposal 118 and the Registrant 100. The Domain Share and Price Information 119 may include the number of shares of equity in the Domain Name 101 to be offered, the price per share or any other information deemed important in the negotiated underwriting by the underwriter of the Selected Proposal 118 or the Registrant 100. In a preferred embodiment, this information may then be updated in the Central Repository of Domain Information 108.

A Method for Underwriting Shares of Equity in a Domain Name

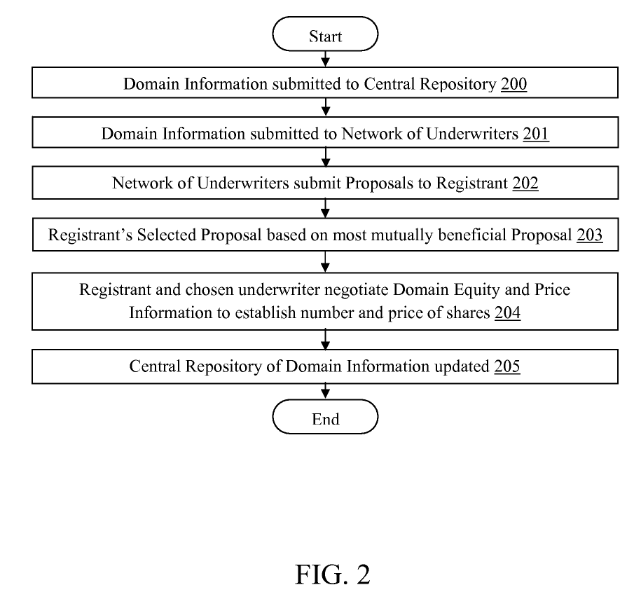

Several different methods may be used to underwrite the sale of shares of equity in a domain name. In a sample embodiment illustrated in FIG. 2, Domain Information may be submitted to a Central Repository of Domain Information (Step 200). The Domain Information may then be submitted to a Network of Underwriters for review (Step 201). After reviewing the Domain Information, the Network of Underwriters may submit Proposals to the Registrant (Step 202). The Registrant may then choose a Selected Proposal based on the most mutually beneficial of the Proposals submitted (Step 203). Next, the Registrant and the underwriter of the Selected Proposal may negotiate Domain Equity and Price Information, which may be related to the establishment of a number of shares of equity for sale and the price of each share (Step 204). Finally, the Central Repository of Domain Information may be updated to reflect the new Domain Equity and Price Information (Step 205).

A Registrant 100 may submit Domain Information 102 to a Central Repository of Domain Information 108 (Step 200) capable of domain information storage and submission. By submitting the Domain Information 102 to the Central Repository of Domain Information 108 (Step 200), the Registrant 100 may be spared the frustration of having to repeatedly re-enter information.

The first centralized submission of domain information may take place where the Domain Information 102 is submitted to a Network of Underwriters 110 (Step 201) interested in underwriting the sale of shares of equity in the Domain Name 101. In a preferred embodiment of the invention, this submission of Domain Information 102 (Step 201) may be completely automated, so that such submission of the Domain Information 102 may be automatically submitted to the Network of Underwriters 110 (Step 201) without review by the Registrant 100.

However, if desired, the Registrant 100 may use Automated Submission Forms 109 to submit Domain Information 102 to the Network of Underwriters 110 (Step 201). The Network of Underwriters 110 may then be provided with the domain information needed to compete for the ability to underwrite the sale of shares of equity in the Domain Name 101.

The submission of the Domain Information 102 to the Network of Underwriters 110 (Step 201) may begin the process of securing Proposals 117 to fund the sale of shares of equity in the Domain Name 101. The Network of Underwriters 110 may review the submission of Domain Information 102, and may weigh the benefits of the domain name's Business Plans 106 and may compare them with the Potential Investment Risks 107 involved in underwriting the sale of shares of equity in the Domain Name 101.

The Network of Underwriters 110 may then respond by submitting one or more Proposals 117 to the Registrant 100 (Step 202). The Registrant 100 may then receive notification of the Proposals 117. This notification may be provided by any means, including, but not limited to email, texting, paging, fax, etc. through a BLACKBERRY, cell phone, PDA, or any electronic means of communication capable of such notification known in the art or developed in the future.

In a preferred embodiment, a threshold number of Proposals 117 may be chosen. If a number of Proposals 117 is greater than the threshold number received, only the best threshold amount of the threshold number may be presented. However, if the threshold number is not reached, all Proposals 117 may be presented. In a non-limiting example, if the threshold of Proposals 117 is set at 5, and 10 proposals are received, only the best 5 proposals may be presented. However, if only 3 proposals are received, all 3 proposals may be presented.

The Registrant 100 may then review the Proposals 117 from the Network of Underwriters 110. The Registrant's 100 Selected Proposal 118 may be the most mutually beneficial proposal (Step 203) from the Proposals 117 received. The Selected Proposal 118 may then be used to fund the sale of shares of equity in the Domain Name 101, and may be determined by matching the ability of one or more underwriters in the Network of Underwriters 110 to fund the sale of shares of equity in the Domain Name 101 based on relevant Domain Information 102.

The Registrant 100 and the underwriter of the Selected Proposal 118 may then work together to establish the details of the sale of shares of equity in the Domain Name 101. The Registrant 100 and the chosen underwriter may negotiate certain Domain Equity and Price Information 119 including but not limited to the number of shares and the price of the shares to be offered (Step 204). In an exemplary embodiment, the share price may be determined based on Domain Information 102, such as Domain Performance based on cash flow metrics or market indicators 105. The newly negotiated Domain Equity and Price Information 119 may then be added and submitted so that the Central Repository of Domain Information 104 is updated (Step 205).

A system for Protecting a Domain Name During a Sale of Shares of Equity

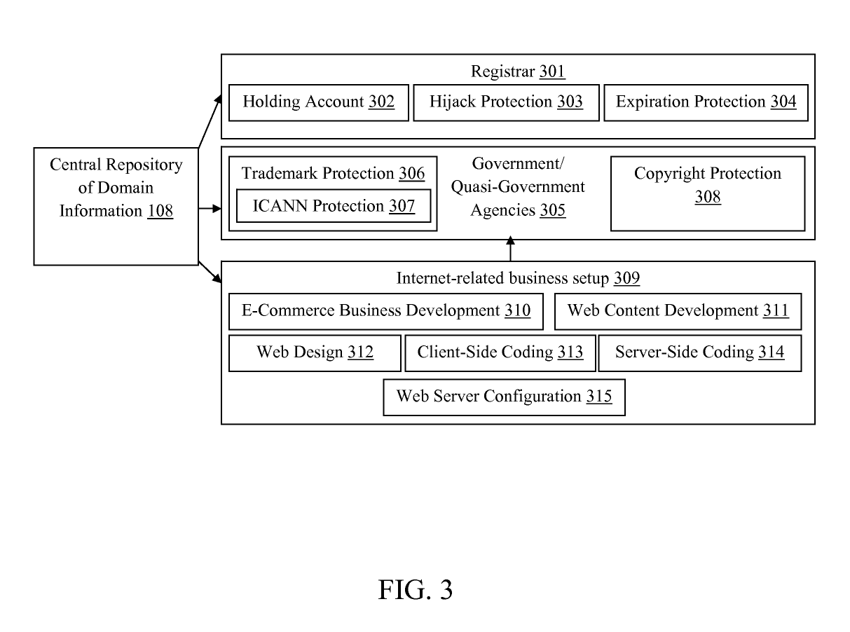

A sample embodiment of a system for protecting a domain name during a sale of shares of equity in the domain name is illustrated in FIG. 3. The illustrated embodiment includes one or more Registrars 301 capable of protecting the Domain Name 101 during the sale of shares of equity in the Domain Name 101.

Domain name protection in the illustrated embodiment may be provided by one or more Registrars 301, a company accredited by the Internet Corporation for Assigned Names and Numbers (ICANN) to register domain names. The Registrar 301 may have the authority to modify domain names. The Registrar 301 may be capable of, but not limited to adding, modifying or deleting domain names or their related domain information. As such, the Registrar 301 may offer protections to prevent the unauthorized transfer of a domain name to another party.

Another embodiment of a system for protecting a domain name during a sale of shares of equity in the domain name is illustrated in FIG. 3. The illustrated embodiment includes one or more Central Repositories of Domain Information 108, including information relating to the Registrant 100 and the Domain Information 102; one or more Registrars 301 capable of protecting the Domain Name 101 during the sale of shares of equity in the Domain Name 101; Government and/or Quasi-Government Agencies 305 capable of intellectual property (IP) protection; and an Internet-Related Business Setup 309 for the Domain Name 101.

Additional elements from the example embodiment of a system for protecting a domain name during the sale of shares of equity in the domain name are not seen in FIG. 3, but are illustrated in FIG. 1, and have been disclosed in detail with examples above. These additional elements include one or more Registrants 100, one or more Domain Names 101 owned by Registrant 100; and a plurality of Domain Information 102 relating to the Domain Name 101 and the Registrant 100.

In a preferred embodiment, the Registrar 301, Government and/or Quasi-Government Agencies 305 and Internet-Related Business Setup 309 are capable of accepting or requesting information from the Central Repository of Domain Information 108 in order to better accommodate protection of the Domain Name 101 and the Internet-Related Business Setup 309.

As seen in FIG. 3, such protections may comprise a Holding Account 302, Hijack Protection 303, Expiration Protection 304, or any combination thereof. As non-limiting examples, such protections may be offered as assurances that the Domain Name 101 is neither lost nor stolen, does not lapse, is not inadvertently or fraudulently transferred to another entity, or any combination thereof.

A Holding Account 302 may comprise any means which allow the registrar 301 to transfer a Domain Name 101 into a secure account, thereby allowing the Domain Name 101 to act as collateral to the underwriters of the Selected Proposal 118, and as needed, to the Registrant 100 during the sale of shares of equity in the Domain Name 101 thereby protecting the Domain Name 101.

Hijack Protection 303, which may be used in addition to the Holding Account 302 to augment the protection provided by the Registrar 301, may comprise any means which prevent a Domain Name 101 or the identity of a registrant from being stolen from the rightful owner.

By way of example and not limitation, Hijack Protection 303 may include private domain name registration such as Go Daddy Group's DOMAIN BY PROXY (to make the registrant's information unavailable to potential hijackers), means for ignoring domain name transfer requests, means for ignoring domain name transfer notices, means for blocking emails which may contain transfer requests, means for declining emails which may contain transfer requests, any other means of preventing the theft of the domain name or a Registrant's 100 identity, or any combination thereof.

Expiration Protection 304, which may be used in addition to the Holding Account 302 to augment the protection provided by the Registrar 301, may comprise any means which prevent a registrant from failing to renew a domain name so that the registrant is no longer the owner of a domain name and the domain name is available for someone else to register.

By way of example and not limitation, Expiration Protection 304 may include an automatic renewal of the domain name, a registrar renewing the domain name and allowing the registrant to reimburse the registrar, the registrar transferring the domain name into the registrar's name and transferring it back to the registrant when the registrar has been reimbursed, or any other means of preventing the failure of a registrant to renew a domain name or combination thereof.

Government/Quasi-Government Agencies 305 may comprise one or more government or quasi-government agencies capable of protecting the IP rights of a domain name or a registrant. Such IP protection may be provided through such government or quasi-government agencies as the United States Patent and Trademark Office (USPTO), United States Copyright Office (USCO) and ICANN. These examples are non-limiting and may apply to any one or more government or quasi-government agencies capable of protecting the IP rights of a registrant or domain name.

In a preferred embodiment, the Government or Quasi-Government Agencies 305 are capable of accepting information from the Central Repository of Domain Information 108 in order to better provide the IP rights and protections of the Domain Name 101. As seen in FIG. 3 such rights and protections may further comprise Trademark Protection 306, additional ICANN Protection 307 relating to Trademark Protection 306, and Copyright Protection 308. These rights and protections may also be submitted to or requested from the Government and/or Quasi-Government Agencies 305 during an Internet-Related Business Setup 309.

Trademark protection 306 may include the receipt of important legal rights by registering a trademark in a domain name with the USPTO to give a registrant substantial legal protections and rights to prevent others from using domain names confusingly similar to the registrant's trademarked domain name. ICANN protection 307 may include additional protection under ICANN's related laws and policies. Non-limiting examples of these laws and policies include ICANN's Uniform Domain Name Dispute Resolution Policy, the Lanham Act and the Anti-Cybersquating Piracy Act.

Copyright Protection 308 includes not only those limited legal rights and protections automatically provided to the owner of a domain name and website in the United States, but also the additional rights and protections provided by inserting a copyright symbol, date and name of the owner of the domain related content with the content and the maximum rights and protections available by obtaining a copyright registration for the relevant content with the USCO.

The Internet-Related Business Setup 309 may be used to create an Internet-related business for the Domain Name 101 prior to or during the sale of shares of equity in the Domain Name 101. The Internet-Related Business Setup 309 may include the tools needed to design the necessary graphics and web pages, develop Internet applications and create electronic business in order to establish an online presence associated with the Domain Name 101.

As seen in FIG. 3, such tools may include, but are not limited to, E-Commerce Business Development 300, Web Content Development 311, Web Design 312, Client-Side Coding 313, Server-Side Coding 314 and Web Server Configuration 315. Non-limiting examples of client-side coding includes CSS, XHTML, Javascript, Flash, Java Applets, or any other client side coding now known or later developed in the art. Non-limiting examples of server-side coding includes PHP, ASP, ASP.NET, CGI/Perl, Java servlets, or any other server side coding now known or later developed in the art.

A Method for Protecting a Domain Name During the Sale of Shares of Equity

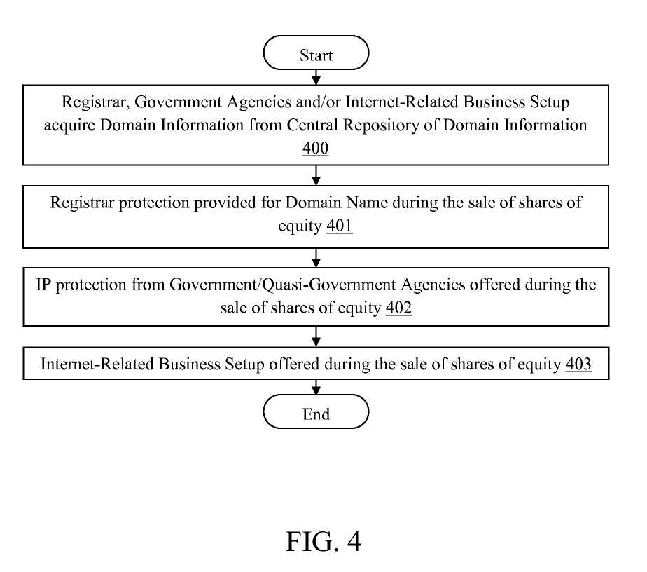

Several different methods may be used to protect a domain name during a sale of shares of equity in the domain name. In a sample embodiment illustrated in FIG. 4, the Registrar, the relevant IP related Government and/or Quasi-Government Agencies and/or the Internet-Related Business Setup may acquire Domain Information from the Central Repository of Domain Information (Step 400). The acquired Domain Information is used in the Registrar protection which is provided for the Domain Name during the sale of shares of equity in the Domain Name (Step 401). Additional IP protection from the appropriate Government Agencies may also be offered during the sale of shares of equity in the Domain Name (Step 402). Finally, an Internet-Related Business Setup is offered during the sale of shares of equity in the domain name (Step 403) to provide an Internet business environment for the Domain Name.

In an example embodiment, in order to offer the most efficient domain name protection desired by both the Registrant 100, the underwriter of the Selected Proposal 118 and any other potential investors, the Central Repository of Domain Information 104 may automatically submit the Domain Information 102 to the Registrar 301, which may then initiate domain name protection, assuring that such protection is provided as quickly as possible. Likewise, the Registrar 301 may be capable of accepting information from the Central Repository of Domain Information 108 in order to better accommodate protection of the Domain Name 101.

The Registrar 301 may then provide protection for the Domain Name 101 during the sale of shares of equity in the Domain Name 101 (Step 401). The protection provided by the Registrar 301 may be specifically to protect a domain name from an undesired transfer of ownership during any relevant steps of a sale of shares of equity in the Domain Name 101. Such Registrar protection may be provided in one of three ways. First, as previously mentioned, the Registrant 100, underwriters of the Selected Proposal 118, or other potential investors may prefer that the Domain Name 101 be protected to reduce some risk associated with performing the sale of shares of equity in the Domain Name 101. To accomplish this, the Domain Name 101 may be transferred into a special domain name Holding Account 302 as collateral to assure that the Domain Name 101 is secure.

In addition to moving the Domain Name 101 into a Holding Account 302, a Registrar 301 may augment the protection provided for the Domain Name 101 through Hijack Protection 303 and Expiration Protection 304. These additional protections provided by the Registrar 301 may ensure that the Domain Name 101 is not lost, does not lapse, and/or is not inadvertently or fraudulently transferred to another entity.

In a non-limiting example, domain hijackers may transfer a domain name away from the lawful owner or change the registrant information and/or name servers in WHOIS records. Domain Hijack Protection 303 may therefore be highly desired to prevent such theft. Registrar 301 protection may also include automatic renewal of the Registrant's 100 Domain Name 101 if the Registrant 100 did not renew the domain name. If the Registrant 100 allows the domain name registration period to lapse, the Domain Name 101 may be lost and the equity in the Domain Name 101 will be worthless. Thus, the Registrar 301 may also provide Expiration Protection 304 to protect the Domain Name 101 from a lapse of ownership of the Domain Name 101.

IP protection and rights from the Government and/or Quasi-Government Agencies 305 may also be offered during the sale of shares of equity in the Domain Name 101 (Step 402). These rights may be acquired before, during or after the Registrar 301 protection described above has been provided for the Domain Name 101 or at any time during the sale of shares of equity in the Domain Name 101. This may include during an Internet-Related Business Setup 309, described below.

The Internet-Related Business Setup 309 may likewise be offered during the sale of shares of equity in the Domain Name 101 (Step 403) to better personalize any Internet website related to Domain Name 101 for potential online customers. The Internet-Related Business Setup 309 may also be an ideal opportunity, if not previously completed to take advantage of the Central Repository of Domain Information 108 to pursue IP protection and rights from Government Agencies 305 through Trademark Protection 306, Copyright Protection 308 and/or ICANN Protection 307.

Once the Domain Name 101 is secure, the sale of shares of equity in the Domain Name 101 may be performed, including sales of domain name equity and the collection of funds for business starting capital. Equity sales in a domain name may determine a percentage of a stock holder's ownership, dividends based on profits, and voting rights in business decisions of the domain name.

The capital raised from the sale of shares of equity in the Domain Name 101 may then be used to launch, improve or maintain a domain Related Organization 104. The use of this capital may be overseen to be in compliance and for the purposes outlined in the Business Plans 106 submitted to the Central Repository of Domain Information 108.

A Streamlined System for Underwriting and Protecting a Domain Name

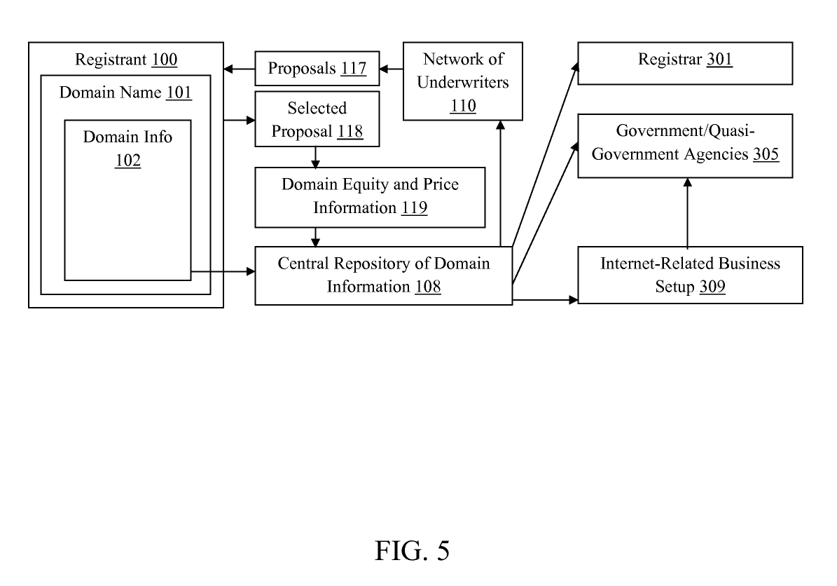

A streamlined example embodiment of a system for underwriting equity in and protecting a domain name during the sale of shares of equity in the domain name is illustrated in FIG. 5. The example demonstrates how two of the example embodiments presented above may be used together in underwriting the equity in and protecting a domain name during the sale of shares of equity in a domain name. FIG. 5 also demonstrates the utility of the Central Repository of Domain Information 108, and its ability to submit information to the Network of Underwriters 110 and accept updated information relating to Domain Equity and Price Information 119 during the underwriting of equity and its ability to submit information to the Registrar 301, Government Agencies 305 and Internet-Related Business Setup 309 during the protection of the Domain Name 101.

Although the systems and methods presented for underwriting a sale of shares of equity in a domain name, protecting a domain name during the sale of such equity and the creation of an Internet-related business setup for a domain name have been presented in the context of a sale of shares of equity in a domain name, those of skill in the art will recognize that these systems and methods would be equally valid in any initial or secondary market for such equity or at any other point of sale of such equity and should not be limited to the examples presented herein.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

We claim:

1. A method comprising the step of protecting a Domain Name from an undesired transfer of ownership during a sale of shares of equity in the Domain Name.

2. The method of claim 1 further comprising the step of transferring the Domain Name into a Holding Account before or during the sale of shares of equity in the Domain Name.

3. The method of claim 2 further comprising the steps of:
a. protecting the Domain Name from theft through Hijack Protection before or during the sale of shares of equity in the Domain Name.
b. protecting the Domain Name from a lapse of ownership through Expiration Protection before or during the sale of shares of equity in the Domain Name; and

4. The method of claim 3 further comprising the steps of
a. offering Trademark Protection and legal rights as recognized by one or more appropriate Government Agencies wherein the Trademark Protection and legal rights further comprise:
i. ICANN Trademark Protection under relevant domain-related ICANN laws and policies; and
b. offering Copyright Protection and rights as recognized by one or more appropriate Government Agencies.

5. The method of claim 4 further comprising the step of offering and providing an Internet-Related Business Setup for the Domain Name during the sale of shares of equity in the Domain Name.

6. A system comprising means for protecting a Domain Name from an undesired transfer of ownership during a sale of shares of equity in a Domain Name.

7. The system of claim 6 further comprising means for moving a Domain Name into a Holding Account to protect the Domain Name during the sale of shares of equity in the Domain Name.

8. The system of claim 7 further comprising:
a. means for protecting the Domain Name from being hijacked during the sale of shares of equity in the Domain Name.
b. means for protecting the Domain Name from Expiration during the sale of shares of equity in the Domain Name; and

9. The system of claim 8 further comprising:
a. means for attaining Trademark Protection and legal rights as recognized by one or more appropriate Government Agencies, the Trademark Protection and legal rights further comprising:
i. ICANN Trademark Protection under relevant domain-related ICANN laws and policies; and
b. means for attaining Copyright Protection and rights as recognized by one or more appropriate Government Agencies.

10. The system of claim 9 further comprising means for setting up an Internet-Related Business for the Domain Name during the sale of shares of equity in the Domain Name.
